(19) United States
(12) Patent Application Publication
(10) Pub. No.: US 2018/0087120 A1
(43) Pub. Date: Mar. 29, 2018

(54) METHOD AND APPARATUS FOR TREATING IRON-CONTAINED RAW MATERIAL USING BATH SMELTING FURNACE

(71) Applicant: Institute of Process Engineering, Chinese Academy of Sciences, Beijing (CN)

(72) Inventors: Tao Qi, Beijing (CN); Lingyun Yi, Beijing (CN); Desheng Chen, Beijing (CN); Lina Wang, Beijing (CN); Hongxin Zhao, Beijing (CN); Yahui Liu, Beijing (CN); Weijing Wang, Beijing (CN); Hongdong Yu, Beijing (CN)

(73) Assignee: Institute of Process Engineering, Chinese Academy of Sciences, Beijing (CN)

(21) Appl. No.: 15/716,582

(22) Filed: Sep. 27, 2017

(30) Foreign Application Priority Data
Sep. 28, 2016 (CN) 201610856794.0

(51) Int. Cl. C21B 13/00; C21B 13/10; C21B 11/08; C21B 3/02; F27D 3/16

(52) U.S. Cl. CPC C21B 13/0006; C21B 13/006; C21B 13/10; F27D 2003/164; C21B 3/02; F27D 3/16; C21B 2200/00; C21B 11/08

(57) ABSTRACT

The present invention relates to method and apparatus for treating iron-contained raw material using bath smelting furnace. An iron-contained raw material is mixed with a reducing agent. The mixture is added into a bath smelting furnace. The enriched oxygen is blown into the bath. The smelt is conducted at a temperature of 1200-1600° C. Compared with the traditional process of “sintering/pellet-blast furnace smelting” or “rotary furnace reduction-electrical furnace smelting separation”, the present invention has the remarkable advantages of short process, strong raw material adaptability, high product quality, low energy consumption, low pollution, etc. The present invention provides a new technology direction for effectively and comprehensively utilizing the iron-contained resource and has a wide application prospect.

### CROSS REFERENCE TO RELATED APPLICATIONS

This application is based upon and claims priority to Chinese Patent Application No. 201610856794.0, filed on Sep. 28, 2016, the entire contents of which are incorporated herein by reference.

### TECHNICAL FIELD

The present invention relates to the field of the metallurgical technology and comprehensive utilization of mineral resources, particularly relates to a method and apparatus for treating iron-contained raw material using bath smelting furnace.

### BACKGROUND

Around the world, nowadays, the methods for treating iron-contained raw material are as below. (1) The process of blast furnace-converter includes a plurality of parts: sintering/pellet, coking, blast furnace, and converter, etc. The auxiliary processes of coking, sintering and the like have a high energy consumption and account for about 60% to 70% of the steel production energy consumption and cause serious pollution. Thus, the auxiliary processes are the primary object of environmental governance. In “Adjusting and Promoting Plan of the Steel Industry”, China makes the “reinforcing the R&D and test of cleaning process technology with a new process for non-blast furnace smelting-steelmaking, refining-direct rolling” a key task for pushing the energy conservation and emission reduction of the steel industry. (2) In the process of rotary hearth furnace-electrical furnace, the heating of rotary hearth furnace completely relies on the radiation heat transfer. Moreover, the combustion flame and exhaust gas cannot contact the carbon pellet-contained material layer at all. The heat transfer efficiency is low and the reduction effect is undesirable. Moreover, the equipment is similar to the annular heating furnace, which has a complex structure, a high operating cost, a high production control requirement, and an unstable product quality. The material pre-reduced by the rotary hearth furnace is subsequently melted and separated by an electrical furnace to achieve the purpose of separating the iron from the slag. (3) In the process of reduction-grinding selection, the iron-contained raw material is reduced in the solid state to sufficiently reduce the iron oxide into the metallic iron which grows to a certain granularity. Next, fine grinding and selection are conducted to obtain iron and slag. Such process requires that a metallization rate of the reduction process is greater than 90%, and the iron grains need to grow to a certain granularity. Thus, accidents such as corrosion of reduction equipment and ring formation happen frequently. Additionally, in terms of the production scale, the reduction-grinding selection process cannot be compared with the blast furnace process and the reduction-smelting separation process. The reduction-grinding selection process is difficult to industrialize. To conclude, the existing technology processes all need two steps, or even a plurality of steps to achieve an effective separation of iron and slag, and carry drawbacks such as long process, high investment, high cost, serious pollution, low product quality and the like.

### SUMMARY

One object of the present invention is that with respect to the drawbacks of the existing smelting process for the iron-contained raw material, a method for treating iron-contained raw material using bath smelting furnace is provided for the first time. The method has a short process, high reaction efficiency, low environmental pollution, and a wide application prospect

Another object of the present invention is to provide an apparatus for treating iron-contained raw material using bath smelting furnace, which has a simple structure, easy operation, applicability for industrialization, and an excellent smelting effect obtained by simple smelting.

The technical solution of the present invention provides a method for treating iron-contained raw material using bath smelting furnace. The iron-contained raw material and reducing agent are mixed and added into the bath smelting furnace. The enriched oxygen is blown into the bath. The smelting is conducted at a temperature of 1200 to 1600° C.

The present invention further includes the following preferred technical solutions:

In the preferred solution, an additive, an iron-contained raw material, and a reducing agent are mixed and added into a bath smelting furnace.

In the preferred solution, a mass ratio of the iron-contained raw material to the reducing agent is 100:(20-60).

In the preferred solution, a smelting time is 0.5-4 hours.

In the preferred solution, the mass ratio of the iron-contained raw material, the additive, and the reducing agent is 100:(0-60):(20-60).

In the preferred solution, the additive is one or more items selected from the group consisting of sodium carbonate, sodium sulfate, sodium chloride, sodium borate, sodium hydrogen carbonate, limestone, and dolomite.

In the preferred solution, the reducing agent is one or more items selected from the group consisting of anthracite, bitumite, lignite, and a coke.

In the preferred solution, in the iron-contained raw material, a mass fraction of the TFe is 30%-65%.

In the preferred solution, in the iron-contained raw material, the mass fraction of V₂O₅ is 0%-2.0%.

In the preferred solution, in the iron-contained raw material, the mass fraction of TiO₂ is 0%-35%.

In the preferred solution, in the enriched oxygen, a volume concentration of oxygen is 40%-80%.

The present invention can directly treat a furnace burden with a moisture content of 6%-8%.

The traditional smelting method requires dry material to be added into the furnace. However, the present invention can process the furnace burden with the moisture content of 6%-8%.

In the preferred solution, a molar ratio of oxygen atom in the enriched oxygen to carbon atom in the reducing agent is 0.4-1.0.

In the present invention, the raw material may be directly added into the smelting furnace for smelting without mixing and granulating.

However, the raw material can also be added into the smelting furnace for smelting after granulating.

The metallic iron and the furnace slag generated by the smelting are separated into two layers, where the lower layer is the metallic molten iron, and the upper layer is the furnace slag.

The molten iron is discharged through metal outlet 18 of the enriched oxygen side-blown bath smelting furnace. Next, iron casting or steel-making process is conducted.

The furnace slag is discharged through slag outlet 17 of the enriched oxygen side-blown bath smelting furnace. Next, a valuable component extraction process is conducted.

The smoke and exhaust gas go through to a waste heat recovery and a dust recovery. The dust is returned to be recycled as an iron-contained material. The exhaust gas is discharged after desulfurated to meet the standard.

The present invention further includes an apparatus for treating iron-contained raw material using bath smelting furnace. An enriched oxygen tuyere 3 is arranged 0.3-0.6 m lower than a surface of the bath and is on a side wall of the bath.

The special arrangement of enriched oxygen tuyere 3 ensures the intense stirring of the melt, the escape of the gas phase of reaction product, and the combustion of fuel.

In the preferred solution, hearth 2 is arranged 0.8-1.2 m lower than enriched oxygen tuyere 3.

In the hearth, there are two layers, i.e., the metal layer and the furnace slag layer. Two layers are continuously discharged from the metal outlet and the slag outlet respectively.

In the preferred solution, the bath smelting furnace includes steel water jacket 10 positioned at an upper portion of the bath furnace, copper water jacket 5 positioned at a middle portion of the bath furnace, and hearth 2 positioned at a bottom portion of the bath furnace. Copper water jacket 5 and/or steel water jacket 10 is/are provided with feed inlet 7. Steel water jacket 10 is provided with smoke outlet 9. The lower portion of copper water jacket 5 is provided with enriched oxygen tuyere 3. The upper portion of copper water jacket 5 is provided with secondary tuyere 6. Steel water jacket 10 is provided with tertiary tuyere 8. The side wall of hearth 2 is provided with slag outlet 17 and metal outlet 18.

During the smelting process, the melt is intensely stirred to rapidly fuse and evenly distribute the raw material in the melt.

The beneficial effects of the present invention:

In the existing technology, two steps or even a plurality of steps are necessary to achieve an effective separation of iron from slag.

The present invention can avoid steps of sintering, coking, and the like required in the blast furnace process. The energy consumption and environmental cost are significantly reduced. The present invention is also different from the “rotary furnace-smelting separation” and “reduction-grinding selection” processes that need two steps including reduction and smelting separation/grinding selection to achieve the separation of iron from slag. The present invention has the remarkable advantages of a shorter process, a high reaction efficiency, a low production cost, a low environmental pollution, a vast application prospect, etc.

The present invention has a strong applicability to raw material. The preparation of material is simple. The bath furnace is enabled to process all kinds of furnace burden with complex compositions including partial block material. There is no need to deeply dry the furnace burden (material with 6%-8% of moisture content can be added into the furnace).

With the high-concentration enriched oxygen blast smelting, though a small amount of heat loss is introduced at the copper water jacket of the sidewall of the furnace, normal smelting will continue after a little fuel is replenished.

The bath furnace body is simple, reasonable, and has stable and reliable operation.

With the structure of copper water jacket, the overhaul cycle of the furnace can reach 1.5-2 years.

Corollary equipment of the side-blown bath furnace is simple and requires low investment.

Moreover, a low-grade coal can be used as the fuel for the bath furnace, which satisfies the situation of China. The fuel consumption is low and the operation is simple.

The present invention synchronously achieves the reduction of iron from the iron-contained raw material and the smelting and separation of iron from slag, where the pig iron and slag are produced directly. Therefore, high energy consuming and serious polluting steps of sintering/pelletizing, coking, etc. required in the traditional blast furnace process are avoided. Meanwhile, the two steps of “reduction+smelting separation/grinding selection” in the non-blast-furnace processes including “rotary furnace-smelting separation” and “reduction-grinding selection” etc. are simplified. A new technology is provided for effectively and comprehensively utilizing the iron-contained resource which has wide application prospect.

### BRIEF DESCRIPTION OF THE DRAWINGS

FIG. 1 is an example of a process flowchart of the method for treating iron-contained raw material using bath smelting furnace of the present invention.

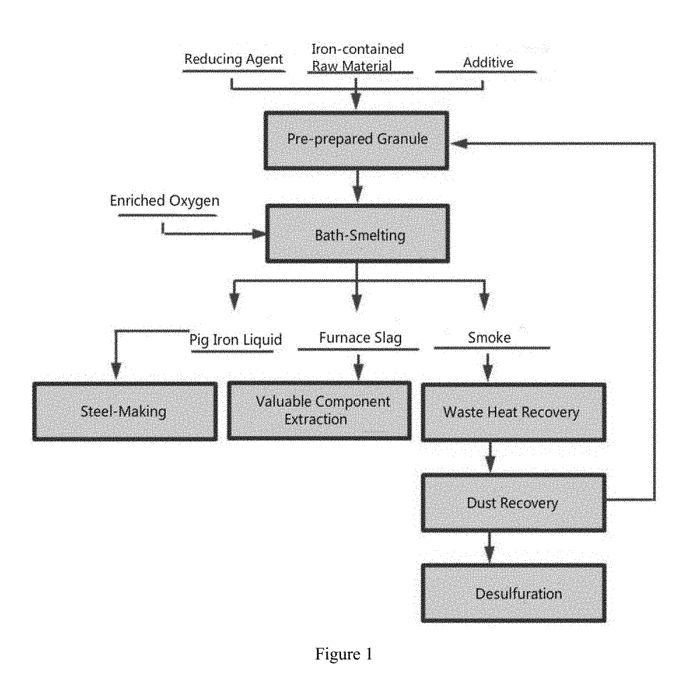

FIG. 2 is a front view of the bath smelting furnace apparatus of the present invention.

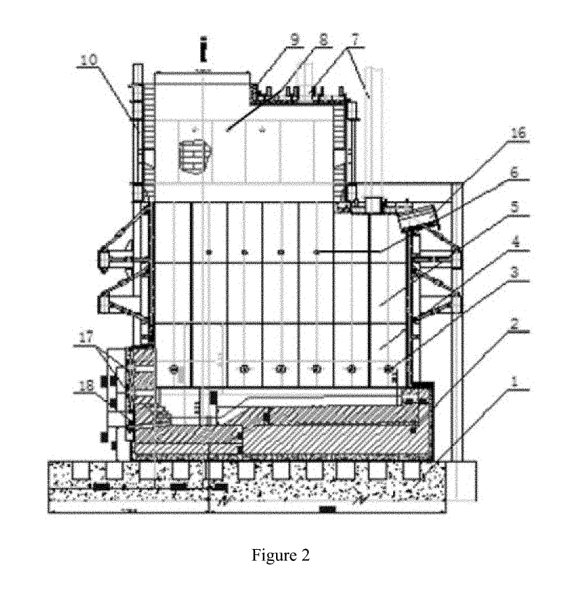

In the drawings,
1—base;
2—hearth;
3—enriched oxygen tuyere;
4,5—copper water jacket;
6—secondary tuyere;
7—feed inlet;
8—tertiary tuyere;
9—smoke outlet;
10—steel water jacket;
17—slag outlet;
18—metal outlet.

### DETAILED DESCRIPTION OF THE INVENTION

The present invention is further described by incorporating the specific embodiments hereinafter.

### Embodiment 1

A side-blown furnace is designed wherein the dimension of the hearth is 1400×2600 mm, and the hearth area is 3.64 m². Both sides of the furnace are respectively provided with four main tuyeres. The positions of the slag outlet and metal outlet are designed to ensure that the depth of the slag layer is 1000 mm and the depth of the metal layer is 300 mm. Four secondary tuyeres are provided 1200 mm above the liquid surface of the bath slag layer, respectively on both sides. Three tertiary tuyeres are provided 1000 mm above the secondary tuyeres, respectively on both sides. A feed inlet of Φ300 mm and a smoke outlet of 400×400 mm are provided.

Test is carried out in the above bath smelting furnace.

One hundred parts of 1# iron-contained raw material are evenly mixed with twenty parts of dolomite and forty parts of coke in a rotary drum granulator. Water is added such that the moisture content of the material is 8%. The granules with a diameter range of 5 mm-10 mm are produced. The granulated material is added into the side-blown bath smelting furnace at a rate of five tons per hour. The smelting temperature is controlled within a range of 1400±50° C. The O₂ concentration of the enriched oxygen blown in from the main tuyere is 60%. The pressure of the enriched oxygen is 0.6 MPa. The flow rate is 4000 Nm³/h. The smelting time is three hours. Under the above conditions, the reduction of iron, the smelting and separation of iron from slag can be achieved. The obtained pig iron grade is 94.5%, and the recovery rate of iron is 94.6%.

### Embodiment 2

The bath smelting furnace is the same as that of the Embodiment 1.

One hundred parts of 2# iron-contained raw material and sixty parts of anthracite are added into the side-blown bath smelting furnace at a rate of six tons per hour. The smelting temperature is controlled within a range of 1600±50° C. The O₂ concentration of the enriched oxygen blown in from the main tuyere is 80%. The pressure of the enriched oxygen is 0.7 MPa. The flow rate is 4500 Nm³/h. The smelting time is four hours. Under the above conditions, the reduction of iron, the smelting and separation of iron from slag can be achieved. The obtained pig iron grade is 92.3%, and the recovery rate of iron is 95.8%.

### Embodiment 2 compared Embodiment 1

The bath smelting furnace is the same as that of the Embodiment 1.

One hundred parts of 2# iron-contained raw material, ten parts of sodium carbonate, and ten parts of coke are added into the side-blown bath smelting furnace at a rate of six tons per hour. The smelting temperature is controlled within a range of 1300±50° C. The O₂ concentration of the enriched oxygen blown in from the main tuyere is 50%. The pressure of the enriched oxygen is 0.6 MPa. The flow rate is 4500 Nm³/h. The smelting time is four hours. Under the above conditions, the reduction of iron is not complete, and the smelting and separation effects of the iron from slag are not satisfactory. The situation where the slag contains iron is serious. The obtained pig iron grade is only 76.6%, and the recovery rate of iron is 64.0%.

### Embodiment 3

The bath smelting furnace is the same as that of the Embodiment 1.

One hundred parts of 3# iron-contained raw material are evenly mixed with sixty parts of sodium carbonate and twenty parts of coke in a rotary drum granulator. Water is added such that the moisture content of the material is 8%. The granules with a diameter range of 5 mm-10 mm are produced. The granulated material is added into the side-blown bath smelting furnace at a rate of six tons per hour. The smelting temperature is controlled within a range of 1300±50° C. The O₂ concentration of the enriched oxygen blown in from the main tuyere is 40%. The pressure of the enriched oxygen is 0.5 MPa. The flow rate is 4000 Nm³/h. The smelting time is three hours. Under the above conditions, the reduction of iron, and the smelting and separation of iron from slag can be achieved. The obtained pig iron grade is 95.8%, and the recovery rate of iron is 98.2%.

### Embodiment 3 Compared Embodiment 2

The bath smelting furnace is the same as that of the embodiment 1.

One hundred parts of 3# iron-contained raw material are evenly mixed with thirty parts of sodium carbonate and twenty parts of coke in a rotary drum granulator. Water is added such that the moisture content of the material is 8%. The granules with a diameter range of 5 mm-10 mm are produced. The granulated material is added into the side-blown bath smelting furnace at a rate of six tons per hour. The smelting temperature is controlled within 1100° C. The O₂ concentration of the enriched oxygen blown in from the main tuyere is 50%. The pressure of the enriched oxygen is 0.5 MPa. The flow rate is 4000 Nm³/h. The smelting time is three hours. Under the above conditions, the products of iron and slag cannot be effectively obtained. The smelting process fails.

### Embodiment 4

The bath smelting furnace is the same as that of the embodiment 1.

One hundred parts of 4# iron-contained raw material are evenly mixed with thirty parts of sodium sulfate and forty parts of coke in a rotary drum granulator. Water is added such that the moisture content of the material is 8%. The granules with a diameter ranged of 5 mm-10 mm are produced. The granulated material is added into the side-blown bath smelting furnace at a rate of five tons per hour. The smelting temperature is controlled within a range of 1500±50° C. The O₂ concentration of the enriched oxygen blown in from the main tuyere is 70%. The pressure of the enriched oxygen is 0.7 MPa. The flow rate is 4500 Nm³/h. The smelting time is four hours. Under the above conditions, the reduction of iron, the smelting and separation of iron from slag can be achieved. The obtained pig iron grade is 92.5%, and the recovery rate of iron is 96.0%.

### Embodiment 4 as Compared Embodiment 3

The bath smelting furnace is the same as that of the Embodiment 1.

One hundred parts of 4# iron-contained raw material are evenly mixed with eighty parts of sodium carbonate and ten parts of anthracite in a rotary drum granulator. Water is added such that the moisture content of the material is 8%. The granule with a diameter ranged of 5 mm-10 mm are produced. The granulated material is added into the side-blown bath smelting furnace at a rate of five tons per hour. The smelting temperature is controlled within a range of 1300±50° C. The O₂ concentration of the enriched oxygen blown in from the main tuyere is 70%. The pressure of the enriched oxygen is 0.7 MPa. The flow rate is 4500 Nm³/h. The smelting time is four hours. Under the above conditions, the products of iron and slag cannot be effectively obtained. The smelting process fails.

TABLE 1
Main Chemical Compositions of the Four Iron-Contained Raw
Materials in the Embodiments/wt. %

| Ore | | | | | | | |
|---|---|---|---|---|---|---|---|
| sample | | | | | | | |
| number | TFe | TiO₂ | V₂O₅ | SiO₂ | Al₂O₃ | CaO | MgO |
| 1 | 55.33 | 9.65 | 1.95 | 4.60 | 4.52 | 2.01 | 0.60 |
| 2 | 64.78 | 0.12 | 0.03 | 2.13 | 2.65 | 1.01 | 0.57 |
| 3 | 30.06 | 34.67 | 1.03 | 14.37 | 3.02 | 6.95 | 1.29 |
| 4 | 45.38 | 18.58 | 1.52 | 8.66 | 2.56 | 3.27 | 0.88 |

Moreover, the present invention may also have a variety of embodiments. Artisans who are familiar with the art can make various corresponding modifications and variations based on the disclosure of the present invention without departing from the spirit and substance of the present invention. However, the corresponding modifications and variations should belong to the protective scope of the appended claims.

What is claimed is:

1. A method for treating iron-contained raw material using bath smelting furnace, comprising:
mixing an iron-contained raw material with a reducing agent to form a mixture;
adding the mixture into a bath smelting furnace;
blowing enriched oxygen into the bath; and
smelting at a temperature of 1200-1600° C.

2. The method of claim 1, further comprising, adding an additive to the iron-contained raw material and the reducing agent to form the mixture; and
adding the mixture into the bath smelting furnace for smelting;
wherein the smelting time is 0.5-4 hours.

3. The method of claim 2, wherein, a mass ratio of the iron-contained raw material, the additive, and the reducing agent is 100:(0-60):(20-60).

4. The method of claim 2, wherein, the additive is one or more items selected from the group consisting of sodium carbonate, sodium sulfate, sodium chloride, sodium borate, sodium hydrogen carbonate, limestone, and dolomite.

5. The method of claim 1, wherein,
the reducing agent is one or more items selected from the group consisting of anthracite, bitumite, a lignite, and a coke; and
the mass ratio of the iron-contained raw material to the reducing agent is 100:(20-60).

6. The method of claim 1, wherein, the iron-contained raw material comprises TFe, V₂O₅, and TiO₂; wherein a mass fraction of TFe is 30%-65%, a mass fraction of V₂O₅ is 0%-2.0%, and a mass fraction of TiO₂ is 0%-35%.

7. The method of claim 1, wherein, an oxygen volume concentration of the enriched oxygen is 40%-80%.
a molar ratio of oxygen atom in the enriched oxygen to carbon atom in the reducing agent is 0.4-1.0.

8. A bath smelting furnace apparatus for treating iron-contained raw material, comprising:
an enriched oxygen tuyere arranged 0.3-0.6 m lower than a bath surface and on a sidewall of the bath;
wherein, an iron-contained raw material is mixed with a reducing agent to form a mixture;
the mixture is added into the bath smelting furnace apparatus;
enriched oxygen is blown into the bath; and
smelting is performed at a temperature of 1200-1600° C.

9. The bath smelting furnace apparatus of claim 8, wherein, a hearth is arranged 0.8-1.2 m lower than the enriched oxygen tuyere.

10. The bath smelting furnace apparatus of claim 8, further comprising:
a steel water jacket, positioned at an upper portion of the bath furnace;
a copper water jacket, positioned at a middle portion the bath furnace; and
the hearth, positioned at a bottom portion of the bath furnace;
wherein
at least one of the copper water jacket and the steel water jacket is provided with a feed inlet;
the steel water jacket is provided with a smoke outlet;
a lower portion of the copper water jacket is provided with an enriched oxygen tuyere;
an upper portion of the copper water jacket is provided with a secondary tuyere;
the steel water jacket is provided with a tertiary tuyere; and
a side wall of the hearth is provided with a slag outlet and a metal outlet.

11. The method of claim 3, wherein, the additive is one or more items selected from the group consisting of sodium carbonate, sodium sulfate, sodium chloride, sodium borate, sodium hydrogen carbonate, limestone, and dolomite.

12. The method of claim 2, wherein,
the reducing agent is one or more items selected from the group consisting of anthracite, bitumite, a lignite, and a coke; and
the mass ratio of the iron-contained raw material to the reducing agent is 100:(20-60).

13. The method of claim 6, wherein, an oxygen volume concentration of the enriched oxygen is 40%-80%.
a molar ratio of oxygen atom in the enriched oxygen to carbon atom in the reducing agent is 0.4-1.0.

14. The bath smelting furnace apparatus of claim 9, further comprising:
a steel water jacket, positioned at an upper portion of the bath furnace;
a copper water jacket, positioned at a middle portion the bath furnace; and
the hearth, positioned at a bottom portion of the bath furnace;
wherein
at least one of the copper water jacket and the steel water jacket is provided with a feed inlet;
the steel water jacket is provided with a smoke outlet;
a lower portion of the copper water jacket is provided with an enriched oxygen tuyere;
an upper portion of the copper water jacket is provided with a secondary tuyere;
the steel water jacket is provided with a tertiary tuyere; and
a side wall of the hearth is provided with a slag outlet and a metal outlet.

15. The bath smelting furnace apparatus of claim 8, wherein,
an additive is added to the iron-contained raw material and the reducing agent to form the mixture; and
the mixture is added into the bath smelting furnace for smelting;
wherein the smelting time is 0.5-4 hours.

16. The bath smelting furnace apparatus of claim 15, wherein, a mass ratio of the iron-contained raw material, the additive, and the reducing agent is 100:(0-60):(20-60).

17. The bath smelting furnace apparatus of claim 15, wherein, the additive is one or more items selected from the group consisting of sodium carbonate, sodium sulfate, sodium chloride, sodium borate, sodium hydrogen carbonate, limestone, and dolomite.

18. The bath smelting furnace apparatus of claim 16, wherein, the additive is one or more items selected from the group consisting of sodium carbonate, sodium sulfate, sodium chloride, sodium borate, sodium hydrogen carbonate, limestone, and dolomite.

19. The bath smelting furnace apparatus of claim 8, wherein,
the reducing agent is one or more items selected from the group consisting of anthracite, bitumite, a lignite, and a coke; and
the mass ratio of the iron-contained raw material to the reducing agent is 100:(20-60).

20. The bath smelting furnace apparatus of claim 15, wherein,
the reducing agent is one or more items selected from the group consisting of anthracite, bitumite, a lignite, and a coke; and
the mass ratio of the iron-contained raw material to the reducing agent is 100:(20-60).

21. The bath smelting furnace apparatus of claim 8, wherein,
the iron-contained raw material comprises TFe, V₂O₅, and TiO₂; wherein a mass fraction of TFe is 30%-65%, a mass fraction of V₂O₅ is 0%-2.0%, and a mass fraction of TiO₂ is 0%-35%.

22. The bath smelting furnace apparatus of claim 8, wherein,
an oxygen volume concentration of the enriched oxygen is 40%-80%.
a molar ratio of oxygen atom in the enriched oxygen to carbon atom in the reducing agent is 0.4-1.0.

23. The bath smelting furnace apparatus of claim 21, wherein,
an oxygen volume concentration of the enriched oxygen is 40%-80%.
a molar ratio of oxygen atom in the enriched oxygen to carbon atom in the reducing agent is 0.4-1.0.
